(19) United States
(12) Patent Application Publication
(10) Pub. No.: US 2023/0018662 A1
(43) Pub. Date: Jan. 19, 2023

(54) Method for Operating a Battery

(71) Applicant: Bayerische Motoren Werke Aktiengesellschaft, Muenchen (DE)

(72) Inventor: Stefan ROEMERSPERGER, Muenchen (DE)

(21) Appl. No.: 17/786,687

(22) PCT Filed: Nov. 17, 2020
(86) PCT No.: PCT/EP2020/082417

§ 371 Date: Jun. 17, 2022

(30) Foreign Application Priority Data
Dec. 19, 2019 (DE) 10 2019 135 313.0

(51) Int. Cl. H02J 7/00; H01M 10/42; H01M 10/48; H01M 10/44; B60L 58/12; B60L 58/22

(52) U.S. Cl. CPC H02J 7/0014; H02J 7/0048; H02J 7/007182; H01M 10/425; H01M 10/482; H01M 10/441; H01M 10/446; B60L 58/12; B60L 58/22; H01M 2010/4271; H01M 2220/20

(57) ABSTRACT

A method for operating a battery having at least two battery cells includes a symmetrization process, in which states of charge of the battery cells are symmetrized continuously or repeatedly; a first measurement process that runs across a first predefined duration during symmetrization and in which measurements are performed repeatedly. In each of the measurements, the battery cell that has the lowest quiescent voltage out of the battery cells in the measurement is determined. It is determined whether the same battery cell was always determined as the battery cell having the lowest quiescent voltage during the first measurement process; and when this is the case a checking process is performed in which symmetrization is interrupted or terminated and it is checked whether the battery cell for which the lowest quiescent voltage was always determined during the first preceding measurement process exhibits increased charge loss that indicates a possible defect.

### BACKGROUND AND SUMMARY OF THE INVENTION

The present invention relates to a method for operating a battery having at least two battery cells and to a battery system having a battery and a control unit which is designed to control the battery.

Batteries that contain a large number of interconnected electrochemical cells are used in electric vehicles. To this end, on the one hand, it must be ensured that the states of charge of the individual cells match one another. This is done by symmetrizing or balancing the cells. On the other hand, it must be identified early enough whether a cell has an increased charge loss because otherwise an internal short circuit or even a thermal event can arise in said cell. The cause of an increased charge loss may be conductive impurities in the cell that are pushed into the separator and cause a short circuit between the anode and the cathode, particularly at the end of a charging process when the pressure in the cell is highest. However, the symmetrization of the cells makes it difficult to establish an increased charge loss in a cell and thus also to identify a defective cell.

The present invention is therefore based on the object of providing a method using which an increased charge loss in a cell in a battery comprising two or more electrochemical cells can be identified safely and reliably.

This object is achieved according to the teaching of the independent claims. Various embodiments and developments of this invention are the subject matter of the dependent claims.

The present invention is also based on the object of providing a battery having two or more electrochemical cells and in which the occurrence of a thermal event is precluded to the greatest possible extent.

The present invention is also based on the object of providing a vehicle having a high-voltage store that has an increased level of safety.

A first aspect of the invention relates to a method for operating a battery having at least two battery cells, comprising:

a symmetrization process in which the states of charge of the battery cells are symmetrized continuously or repeatedly;

a first measurement process that runs over a first predefined period during the symmetrization process and in which measurements are performed repeatedly, wherein, in each of the measurements, the respective battery cell that has the lowest quiescent voltage out of the battery cells in the respective measurement is determined;

establishing whether the same battery cell was always determined as the battery cell having the lowest quiescent voltage during the first measurement process; and

when this is the case:

performing a checking process in which the symmetrization process is interrupted or terminated and a check is carried out to determine whether the battery cell for which the lowest quiescent voltage was always determined during the preceding first measurement process exhibits an increased charge loss that indicates a possible defect.

As a result, in a battery comprising two or more electrochemical cells and the states of charge of which are compensated (symmetrized) by a control unit, it is possible to identify an increased charge loss in a cell safely and reliably and thus the occurrence of a thermal event in the battery can be prevented.

The battery cell with the lowest quiescent voltage can be determined at the start and at the end of the predefined first period. It is also possible to determine which battery cell has the lowest quiescent voltage more times within the predefined first period. In particular, the battery cell with the lowest quiescent voltage can be determined in a manner (substantially) evenly distributed over the predefined first period. It may be advantageous if the states of charge of the battery cells are not symmetrized directly before the battery cell with the lowest quiescent voltage is determined. The battery cells may be lithium-ion cells.

Within the context of the present invention, the terms “balancing” and “symmetrizing” are used synonymously. The balancing or symmetrizing is intended to ensure the uniform electrical charge distribution of all of the electrochemical cells within a battery.

Preferred embodiments of the solid-state battery according to the invention are described below, these embodiments each being able to be combined as desired with one another and with the other described aspects of the invention, provided this is not expressly precluded or technically impossible.

In one preferred embodiment, a measurement of the first measurement process is performed when a control unit that controls the battery wakes up, and

the waking of the control unit changes said control unit from the quiescent mode thereof to the active mode.

As a result, it is possible to ensure in a simple manner that the measurements of the first measurement process are performed repeatedly.

The control unit is preferably woken up cyclically. The control unit may be the battery management system of the battery.

In one preferred embodiment, after the control unit has woken up, first a measurement of the first measurement process is performed and only thereafter are the states of charge of the battery cells possibly symmetrized.

As a result, the equalizing effect of the symmetrization on the states of charge of the cell can be reduced and thus a cell that has an increased charge loss can be detected more easily.

In one preferred embodiment, each performance of a measurement of the first measurement process contains: measuring the quiescent voltage of all of the battery cells contained in the battery; and

ascertaining the lowest quiescent voltage out of the quiescent voltages measured at all of the battery cells.

As a result, the lowest quiescent voltage can be ascertained in a simple manner.

In one preferred embodiment, after each performance of a measurement of the first measurement process, an identifier that characterizes the battery with the lowest quiescent voltage is entered into a history,

the history contains identifiers of battery cells for which a lowest quiescent voltage has been determined, and

it is established, based on identifiers entered in the history within the predefined first period, whether among the battery cells there is a battery cell that always had the lowest quiescent voltage during the predefined first period and which battery cell that is.

As a result, the battery cell that always has the lowest quiescent voltage during the first predefined period can be ascertained efficiently.

In one preferred embodiment, the checking process comprises:

a second measurement process that runs over at most a second predefined period and in which one or more measurements are performed, wherein, in each of the measurements, the following are respectively determined: the lowest quiescent voltage U₁ among the quiescent voltages of the battery cells, the battery cell at which the lowest quiescent voltage U₁ has been determined, the second-lowest quiescent voltage U₂ among the quiescent voltages of the battery cells, and an average quiescent voltage Uₘ, which corresponds to the average value of the quiescent voltages of all of the battery cells; and

establishing an increased charge loss at the battery cell for which the lowest quiescent voltage was always determined during the first measurement process when the lowest quiescent voltage U₁ has been measured at this battery cell and the following equations hold true:

|U₁−U₂|<U_{S1} and |U₁−Uₘ|<U_{S2},

wherein U_{S1} and U_{S2} each represent positive voltage threshold values, and U_{S1} is less than or equal to U_{S2}; and

wherein the second predefined period follows the first predefined period.

As a result, it is possible to establish with a great degree of likelihood that the battery cell that always had the lowest quiescent voltage during the first predefined period also has an increased power loss.

In one preferred embodiment, each performance of a measurement of the second measurement process contains: measuring the quiescent voltage of all of the battery cells contained in the battery;

ascertaining the lowest quiescent voltage U₁ and the second-lowest quiescent voltage U₂ among the quiescent voltages measured at all of the battery cells and the average quiescent voltage Uₘ using the quiescent voltages measured at all of the battery cells; and

determining the battery cell that has the lowest quiescent voltage U₁.

As a result, the quiescent voltages U₁, U₂ and Uₘ can be ascertained in a simple manner.

In one preferred embodiment, the symmetrization process is reactivated after an increased charge loss has been established or, at the latest, after the predefined second period has elapsed.

As a result, it is possible to ensure that the equalization of the states of charge of the battery cells is restarted.

One preferred embodiment further comprises:

reporting an increased charge loss when an increased charge loss is established when the checking process is performed.

As a result, a user can be notified of a possible defect of a battery cell, with the result that they can exchange the affected battery cell at an early stage, even before a thermal event arises.

A second aspect of the invention relates to a battery system, comprising: a battery having at least two battery cells and a control unit coupled to the battery cells, wherein the control unit is designed to carry out the method according to the invention.

As a result, a battery having two or more electrochemical cells in which the occurrence of a thermal event is precluded to the greatest possible extent can be provided.

The battery cells may be lithium-ion cells.

In one preferred embodiment, the control unit comprises a ring memory and the history that contains the identifiers of the battery cells for which a lowest quiescent voltage has been determined is stored in the ring memory.

As a result, identifiers of battery cells that are no longer relevant to the method can be deleted automatically.

A third aspect of the invention relates to a vehicle comprising a battery system according to the invention.

As a result, it is possible to provide a vehicle having a high-voltage store that has an increased level of safety.

In one preferred embodiment, the vehicle is configured to trigger the measurement process when the vehicle is started.

As a result, the safety of a vehicle that contains a high-voltage store can be increased even further.

Further advantages, features and application options of the present invention result from the following detailed description in connection with the figures.

### BRIEF DESCRIPTION OF THE DRAWINGS

FIG. 1 schematically shows a battery system according to the invention; and

FIG. 2 shows the flow diagram of a method according to the invention for operating a battery having at least two battery cells.

### DETAILED DESCRIPTION OF THE DRAWINGS

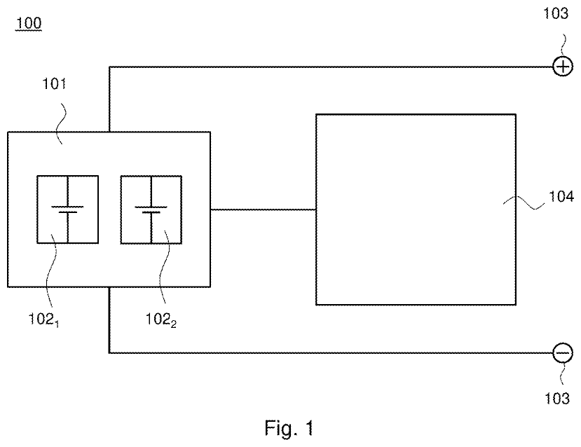

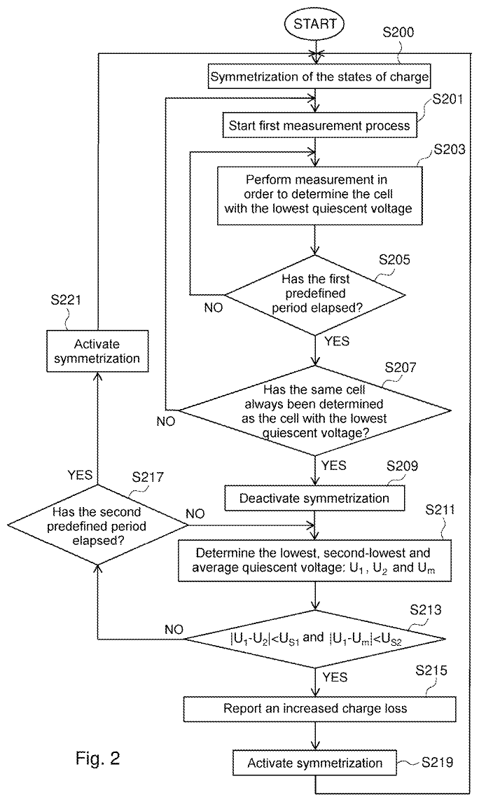

FIG. 1 schematically shows a battery system 100 according to the invention comprising: a battery 101 having at least two battery cells 102₁ and 102₂, and a control unit 104 which is electrically connected to the battery cells. The control unit is designed to carry out the method according to the invention shown in FIG. 2. The battery cells 102₁ and 102₂ contained in the battery 100 are interconnected with one another in such a way that in the charged state the battery 100 can provide a predefined no-load voltage at the connection terminals 103 thereof. The control unit 104 may contain a ring memory, the function of which is described in the text which follows. The control unit 104 may also have a quiescent mode and an active mode and may switch between these two modes. The change from the quiescent mode to the active mode is denoted in the text which follows as the control unit waking up.

FIG. 2 shows the flow diagram of a method according to the invention for operating a battery having at least two battery cells.

In a step S200 of the method, which is also referred to in the text which follows as symmetrization process, the states of charge of the battery cells contained in the battery 100 are symmetrized (or balanced). The battery 100 may contain more than two batteries. During symmetrization, there is a uniform charge distribution among all of the battery cells contained in the battery. The symmetrization or balancing of battery cells is known to a person skilled in the art; it is not dealt with any further for this reason.

In a step S201 of the method, a first measurement process is started. This is described in more detail in the text which follows.

In a step S203, which is associated with the first measurement process, a measurement is performed, in which the battery cell that has the lowest quiescent voltage from the battery cells is determined. A battery cell that has the lowest quiescent voltage can be determined by virtue of i) the quiescent voltage of each battery cell contained in the battery being measured; ii) the lowest quiescent voltage from the quiescent voltages measured at all of the battery cells being ascertained; and iii) the battery cell for which the lowest quiescent voltage has been measured being determined from all of the battery cells contained in the battery. The quiescent voltages are intended to be measured as simultaneously as possible so that the measured quiescent voltages can represent an instantaneous state of the battery cells.

After the measurement of the first measurement process has been performed, an identifier that characterizes the battery cell for which the lowest quiescent voltage has been measured can be entered into a history. The history can be stored in a ring memory which is preferably contained in the memory unit 104.

The measurement of the first measurement process can advantageously be performed when the control unit 104 wakes up. If the battery system 100 is in a vehicle and coupled thereto, the measurement can also be performed when said vehicle is started.

In a step S205, which is associated with the first measurement process, it is established whether a predefined first period has elapsed since the start of the first measurement process. If the predefined first period has elapsed since the start of the first measurement process (YES branch of step S205), step S207 is carried out; otherwise, step S203 is carried out again (NO branch of step S205).

The symmetrization process and the first measurement process can proceed independently of one another. It is therefore possible for the symmetrization process S200 and the first measurement process S203 to overlap in terms of time. For example: a first symmetrization of the symmetrization process can take place at a time t1; a first measurement of the first measurement process that determines the battery cell that has the lowest quiescent voltage at a later time t2 can be performed at the time t2; a second symmetrization of the symmetrization process can take place at a time t3, t3>t2; a second measurement of the first measurement process that determines the battery cell that has the lowest quiescent voltage at a time t4, etc. can be performed at the time t4, t4>t3. After each measurement of the first measurement process, the following can be stored in the history: the identifier of the battery cell having the lowest quiescent voltage and the time at which this was measured.

In step S207, it is established whether the same battery cell as the battery cell with the lowest quiescent voltage has always been determined during the first measurement process. If this is the case, step S209 is carried out (YES branch of S207). If this is not the case, step S201 is carried out and a new first measurement process is started (NO branch of S207).

It is possible to ascertain based on the history whether the same battery cell as the battery cell with the lowest quiescent voltage has always been determined during the first measurement process. The history contains at least the identifiers of the battery cells for which a respective lowest quiescent voltage has been determined during the last-performed first measurement process. If one and the same identifier is always entered in the history for the period of the last-performed first measurement process, the battery cell identified by the identifier is then the one for which the lowest quiescent voltage has always been determined in the first measurement process.

In step S209, the symmetrization process is deactivated and a second measurement process is started. From the deactivation of the symmetrization process up to renewed activation thereof, the symmetrization of the states of charge of the battery cells no longer takes place.

In the step S211, which is associated with the second measurement process, the following takes place: i) the quiescent voltage of each battery cell contained in the battery is measured, ii) the lowest quiescent voltage U₁ and the second-lowest quiescent voltage U₂ from the quiescent voltages measured at all of the battery cells are ascertained, iii) an average quiescent voltage Uₘ is calculated using the quiescent voltages measured at all of the battery cells; and iv) the battery cell at which the lowest quiescent voltage U₁ has been measured is determined.

In the step S213, which follows step S211 and is associated with the second measurement process, it is established: i) whether the battery cell for which the lowest quiescent voltage has always been determined during the first measurement process corresponds to the battery cell at which the lowest quiescent voltage U₁ was measured in the preceding step S211 (of the second measurement process); and ii) whether the following relationships hold true:

|U₁−U₂|<U_{S1} and |U₁−Uₘ|<U_{S2}, (1)

wherein U_{S1} and U_{S2} each represent positive voltage threshold values, and U_{S1} is less than or equal to U_{S2}.

If it is established that the lowest quiescent voltage U₁ has been measured at the battery cell for which the lowest quiescent voltage has always been determined during the first measurement process (that is to say point i) is established affirmatively), and the conditions (1) are satisfied, then step S215 is carried out (YES branch of S213).

If it is established that the battery cell for which the lowest quiescent voltage has always been determined during the first measurement process does not correspond to the battery cell at which the lowest quiescent voltage U₁ was measured in step S211 or one of the two conditions (1) is not satisfied, then step S217 is carried out (NO branch of S213).

In step S215, there is a notification that the battery cell for which the lowest quiescent voltage has always been determined during the first measurement process has an increased charge loss.

In a step S219 following step S215, the symmetrization process is reactivated and the second measurement process is terminated. Step S200 is carried out after step S219.

In step S217, which is associated with the second measurement process, it is established whether a predefined second period has elapsed since the deactivation of the symmetrization process (or the start of the second measurement process). If the predefined second period has elapsed since the deactivation of the symmetrization process (or the start of the second measurement process), step S221 is carried out (YES branch of step S217); otherwise, step S211 is carried out again (NO branch of step S217).

In step S221, the symmetrization process is reactivated and the second measurement process is terminated. Step S200 is carried out after step S221.

While at least one exemplary embodiment has been described previously, it should be noted that a large number of variations thereof exist. It should also be remembered that the exemplary embodiments described are only non-limiting examples, and the intention is not to thereby restrict the scope, applicability or configuration of the devices and methods described here. On the contrary, the preceding description will provide a person skilled in the art with guidance to implement at least one exemplary embodiment, and it goes without saying that various changes to the manner of operation and the arrangement of the elements described in an exemplary embodiment can be made without thereby departing from the subject matter respectively defined in the accompanying claims and from legal equivalents of the subject matter.

### LIST OF REFERENCE SIGNS

100 Battery system
101 Battery
102₁, 102₂ Battery cells
103 Battery connection terminals
104 Control unit

1.-13. (canceled)

14. A method for operating a battery having at least two battery cells, comprising:
a symmetrization process in which states of charge of the at least two battery cells are symmetrized continuously or repeatedly;
a first measurement process that runs over a first predefined period during the symmetrization process and in which measurements are performed repeatedly, wherein, in each of the measurements, a battery cell that has a lowest quiescent voltage out of the at least two battery cells in a measurement is determined;
establishing whether a same battery cell was always determined as the battery cell having the lowest quiescent voltage during the first measurement process; and
performing a checking process in which the symmetrization process is interrupted or terminated and a check is carried out to determine whether the battery cell for which the lowest quiescent voltage was always determined during a preceding first measurement process exhibits an increased charge loss that indicates a possible defect.

15. The method according to claim 14, wherein a measurement of the first measurement process is performed when a control unit that controls the battery wakes up, and
waking of the control unit changes said control unit from a quiescent mode thereof to an active mode.

16. The method according to claim 15, wherein, after the control unit has woken up, first a measurement of the first measurement process is performed and only thereafter are the states of charge of the battery cells symmetrized.

17. The method according to claim 14, wherein each performance of a measurement of the first measurement process contains: measuring a quiescent voltage of all of the at least two battery cells contained in the battery; and
ascertaining the lowest quiescent voltage out of the quiescent voltages measured at all of the at least two battery cells.

18. The method according to claim 14, wherein, after each performance of a measurement of the first measurement process, an identifier that characterizes the battery with the lowest quiescent voltage is entered into a history,
the history contains identifiers of battery cells for which the lowest quiescent voltage has been determined, and
it is established, based on identifiers entered in the history within a predefined first period, whether among the at least two battery cells there is a battery cell that always had the lowest quiescent voltage during the predefined first period and which battery cell that is.

19. The method according to claim 14, wherein the checking process comprises:
a second measurement process that runs over at most a second predefined period and in which one or more measurements are performed, wherein, in each of the measurements, the following are respectively determined: the lowest quiescent voltage U₁ among the quiescent voltages of the battery cells, the battery cell at which the lowest quiescent voltage U₁ has been determined, the second-lowest quiescent voltage U₂ among the quiescent voltages of the at least two battery cells, and an average quiescent voltage Uₘ, which corresponds to the average value of the quiescent voltages of all of the at least two battery cells; and
establishing an increased charge loss at the battery cell for which the lowest quiescent voltage was always determined during the first measurement process when the lowest quiescent voltage U₁ has been measured at this battery cell and the following equations hold true:

|U₁−U₂|<U_{S1} and |U₁−Uₘ|<U_{S2},
wherein U_{S1} and U_{S2} each represent positive voltage threshold values, and U_{S1} is less than or equal to U_{S2}; and
wherein the second predefined period follows the first predefined period.

20. The method according to claim 19, wherein each performance of a measurement of the second measurement process contains: measuring the quiescent voltage of all of the at least two battery cells contained in the battery;
ascertaining the lowest quiescent voltage U₁ and the second-lowest quiescent voltage U₂ among the quiescent voltages measured at all of the at least two battery cells and the average quiescent voltage Uₘ using the quiescent voltages measured at all of the at least two battery cells; and
determining the battery cell that has the lowest quiescent voltage U₁.

21. The method according to claim 19, wherein the symmetrization process is reactivated after an increased charge loss has been established or at the latest after the predefined second period has elapsed.

22. The method according to claim 14, further comprising: reporting an increased charge loss when an increased charge loss is established when the checking process is performed.

23. A battery system, comprising: a battery having at least two battery cells and a control unit coupled to the battery cells, wherein the control unit is designed to carry out the method according to claim 14.

24. The battery system according to claim 23, wherein the control unit comprises a ring memory and the history that contains the identifiers of the battery cells for which a lowest quiescent voltage has been determined is stored in the ring memory.

25. A vehicle, comprising a battery system according to claim 23.

26. The vehicle according to claim 25, wherein the vehicle is configured to trigger the measurement process when the vehicle is started.
